(19) United States
(12) Patent Application Publication
(10) Pub. No.: US 2006/0033616 A1
(43) Pub. Date: Feb. 16, 2006

(54) Smart container gateway

(75) Inventors: R. Scott Silva, Humarock, MA (US); C. James Galley III, Smithtown, NY (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: NaviTag Technologies, Inc., Hingham, MA (US)

(21) Appl. No.: 11/140,610

(22) Filed: May 27, 2005

Related U.S. Application Data
(60) Provisional application No. 60/575,213, filed on May 27, 2004.

(51) Int. Cl. G08B 1/08; G08B 13/14; G08B 23/00

(52) U.S. Cl. 340/539.22; 340/539.26; 340/693.1; 340/572.1

(57) ABSTRACT

A smart container gateway system is provided to improve security and facilitate global secure supply chain operations using smart containers or freight trailers. Each smart container includes a smart container gateway that provides communication with global and local networks, container and cargo security sensors and cargo identification tags. The smart container gateway displaces no interior volume from standard shipping containers, and requires no attachment to any exterior container surface, locking bar or handle. The system includes a central data collection and processing facility for processing container location, security status of the container and cargo and cargo state information collected by at least one smart container gateway and transmitted over a global wireless network. The smart container gateway requires no separate or intermediate communications relay equipment fixed to the cargo transportation vehicle. The smart container gateway is self powered and requires no external antenna. The smart container gateway provides position location without GPS. The smart container gateway communicates with one or more networks by means of an integrated structural RF antenna, power generator and radio control subsystem. One network may be a secure satellite network. Another network may be a local area network. A radio link may be provided to connect the smart container gateway another smart container gateway or to the central data facility in real time, and may be operated remotely from the container to allow direct queries of cargo security status, position location, and other information.

### RELATED APPLICATION

This application claims the benefit of U.S. Provisional Application No. 60/575,213, filed on May 27, 2004 and incorporates herein by reference the entire contents of U.S. patent application Ser. No. 10/455,248, filed Jun. 5, 2003. The entire teachings of the above applications are incorporated herein by reference.

### BACKGROUND OF THE INVENTION

1. Field of the Invention

This invention relates to apparatus and an associated method for energizing a shipping container gateway transceiver through energy received in space from a distant RF source and/or transmitted from a solid structure. More specifically, it relates to such a system wherein the transceiver communicates over one or more wireless networks from structural antenna element, wherein the transceiver is powered by either RF energy or mechanical energy converted by means of direct energy conversion or transduction.

2. Description of the Prior Art

It has long been known in various applications to monitor conditions of cargo or cargo container systems, to provide information by stored memory, data logging or real-time readouts of certain cargo or container states or conditions. Such systems typically have been connected by a suitable wire to a source of electricity at the desired voltage such as line current or batteries or other stored energy source.

It has also been known in the transportation logistics and manufacturing inventory environments systems and technology that monitor in part, components, parts, assemblies, cargo shipments or cargo shipment identity parameters by employing Radio Frequency Identification (RFID) tags or sensors, remote reporting electronic seals, E-seals and other battery powered systems, and digital data processors to effect comparison between the measured conditions, including security status, position location or other cargo information data and reporting and displaying the results.

In spite of the known systems, there remains a need for a remote transceiver usable in various environments and at various distances from the data processing and control facility energized so as not to require hard wired systems or batteries or other stored energy sources.

### SUMMARY OF THE INVENTION

The present invention is an apparatus for an intermodal cargo container or Smart Container Gateway wherein the remote transceiver unit including a structural antenna element that exploits energy available in the electromagnetic and mechanical environment to power the remote transceiver. More particularly, the apparatus includes a structural antenna element, a transceiver unit for obtaining information from a container/cargo/shipment transaction/or other central data control facility. The remote transceiver structural antenna element has energy conversion means for energizing the transceiver by employing conversion of available electromagnetic or mechanical energy.

A power supply is thus provided for energizing the radio transceiver unit by the structural antenna element itself. The structural antenna element may convert available electromagnetic energy to direct current, and the same structural antenna element may convert mechanical energy to direct current for use in a regulated power supply operating independently of primary or other stored energy sources or transportation vehicle power.

The apparatus may be provided with a plurality of transceivers each of which will be a source of different information from the other.

The structural antenna element and smart container gateway apparatus provide a system wherein the transceiver is not required to be part of a hard wired or electromechanical generator system of a prime mover, or to require replaceable batteries.

The structural antenna system provides transceiver power by RF or mechanical power conversion to initiate operation of the transceiver regardless of whether only the RF power is present or whether only the mechanical power is present.

The system thus eliminates the need for replaceable or rechargeable batteries on the smart container gateway, radio transceiver or the use of hard wired systems.

This summary description of the invention will be more fully understood from the following description of the invention and claims on reference to the accompanying drawings.

### BRIEF DESCRIPTION OF THE DRAWINGS

FIG. 1 is a schematic illustration of a form of the present invention showing a gateway including a structural antenna element.

FIG. 2 is a block diagram of components of the gateway.

FIG. 3 is a schematic illustration of a gateway and how it attaches to a door.

FIG. 4 is a schematic illustration of the structural antenna and energy harvesting circuitry.

FIG. 5 is a diagram of an ad hoc gateway network.

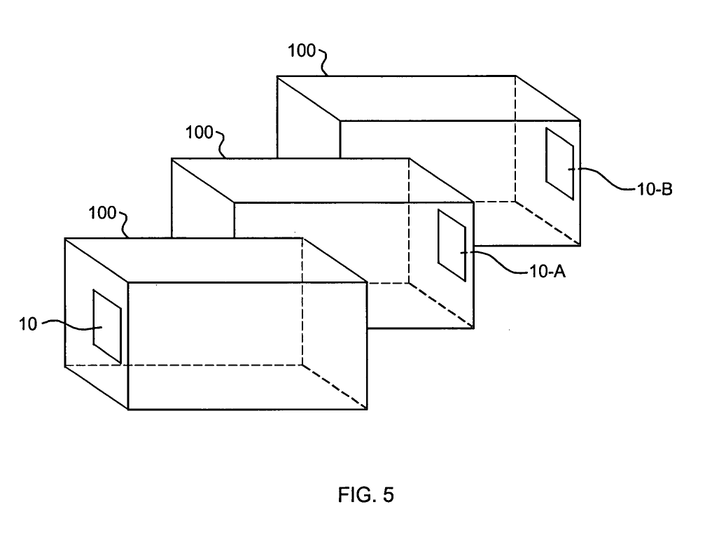

### DETAILED DESCRIPTION OF THE INVENTION

A description of preferred embodiments of the invention follows.

The preferred embodiment of the invention is described below though an example application of a structural antenna element within a smart container gateway environment.

As employed herein, the term “in space” means that energy or signals are being transmitted through the air or similar medium regardless of whether the transmission is within or partially within an enclosure, as contrasted with transmission of electrical energy by a hard wired or printed circuit boards. Likewise, the term “in structure” means that energy or signals are being transmitted through a solid structure or similar medium regardless of whether within or partially within an enclosure rather than drawing power from a generator or stored energy source alone.

As employed herein, the term “smart container gateway” means a self-contained communications system that is applied to a smart container or freight trailer.

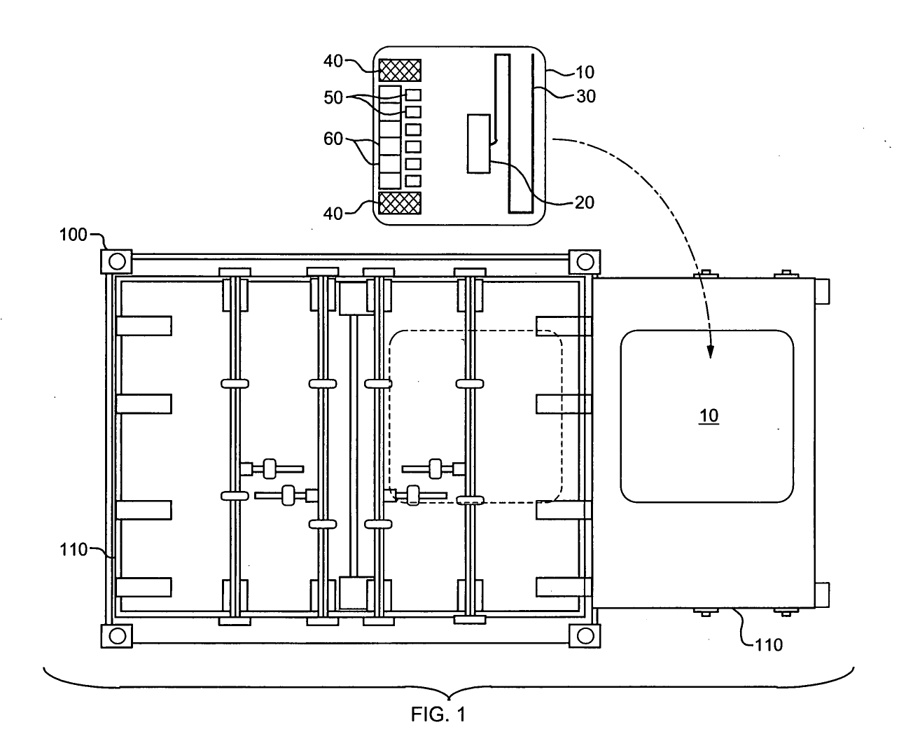

FIG. 1 is a diagram illustrating a shipping container 100 and apparatus called herein a container gateway 10. A shipping container 100, as is well known in the art, contains typically two or more doors 110 on a portion thereof within at least one of the doors 110 is the gateway 10. The gateway 10 is preferably mounted to the inside of the door 110 such that when the door 110 is closed, the presence of gateway 10 is not readily noticeable from external inspection of the container 100. The gateway 10 may be mounted on the inside of the door but still have access through an electromagnetic aperture to receive electromagnetic energy, such as to receive and/or transmit radio signals to the outside world, assuming that the material of the door 110 is at least partially transmissive of such electromagnetic energy.

In general, the gateway 10 includes electronics 20, a communications antenna 30 (which may be a satellite communications antenna), Wireless Local Area Networking transceivers 40, power harvesting modules 50, and optionally, batteries 60.

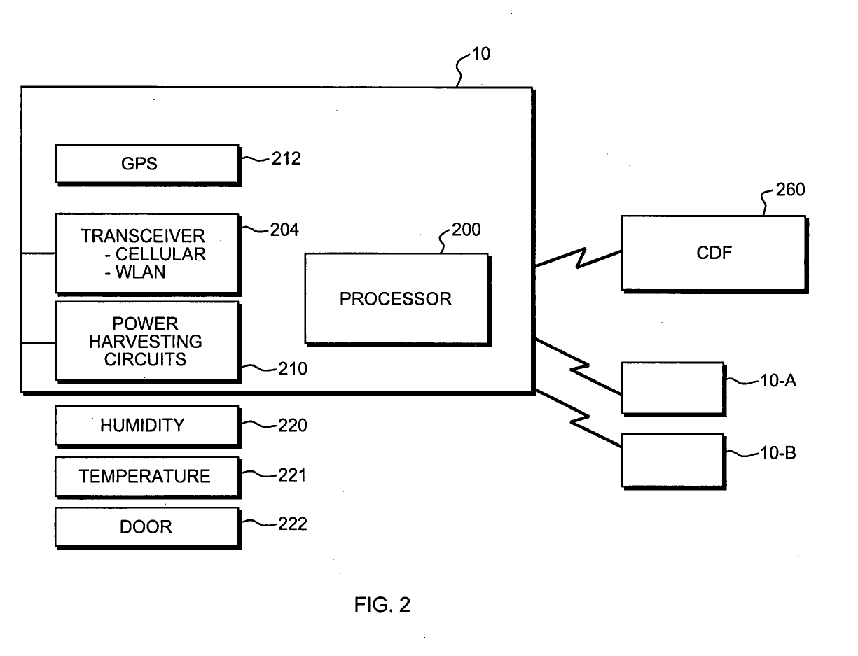

More details of the components of the gateway 10 are shown in FIG. 2. There is included therein a data processor 200, one or more transceivers 204, which optimally include at least a cellular radio telephone and Wireless Local Area Network transceiver, power harvesting circuits 210 (that provide power for the various electronic components of the gateway 10 in a manner that is to be described in greater detail below) and a positional location sensor 212, such as a Global Positioning Sensor (GPS) receiver.

In addition there may be included within the gateway 10 circuitry that couples to sensors that are located within the gateway 10 and/or within the other areas within the associated container. These may include humidity 220, temperature 221 and door status (i.e., open or closed) 222 sensors. As also illustrated in FIG. 2, gateway 10 may form an ad hoc wireless network with other gateways 10-A, 10-B located in the vicinity. This may be made through wireless LAN interfaces or other short range wireless data communication interfaces. In addition, the gateway 10 communicates with a Central Data Facility (CDF) 260 to provide status information. The CDF 260 is typically operated by a chipper, owner of the container, insurance claim system, law enforcement system, customer owner protection system or other similar organization and/or authority that is responsible for the container 100.

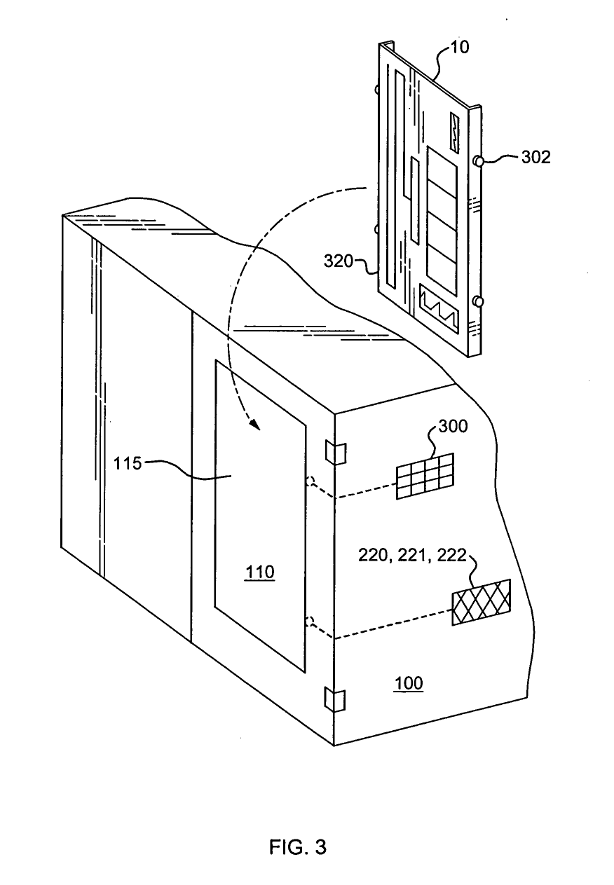

FIG. 3 is more general perspective view of the gateway 10 and its relationship to the container 100 at energy harvesting and power harvesting 210 functions. In particular, the gateway 10 also connects a power interface 302 to a harvesting power source 300. In a preferred embodiment, the harvesting power source 300 is provided by a structural frame 320 of the gateway 10 itself. The structural frame 320 thus functions as an antenna for receiving and transmitting electromagnetic energy to and from the transceivers 204 but also is used as an energy harvesting source to power the gateway by both deriving power from the radio frequency energy received as well as from vibrations detected and harvested from harvesting source 300.

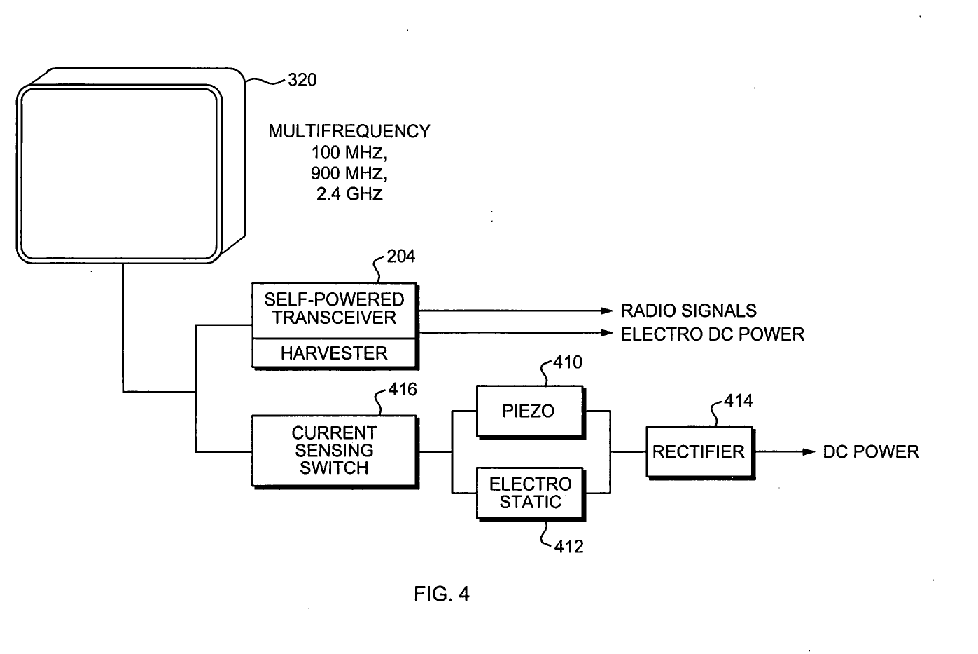

FIG. 4 shows how the frame 320 may be used to generate power for the electronics in the gateway 10. In particular, the frame 320 has visibility through an aperture in the door 110 to receive electromagnetic energy. The electromagnetic energy, with the frame 320 thus acting as an antenna, provides electromagnetic energy to the at least one self-powered portion circuitry transceiver 204. Also, energy can be harvested from ambient RF as well. Thus, excess Direct Current (DC) can be provided by self-powered radio transceiver 204.

The frame 320 is also used to generate power in other ways. In particular, mechanical vibration transducers, which may include piezo electric transducer 410 and/or electrostatic transducer 412 are energized by vibrations received from frame 320 as container 100 travels along a road, ship, or other transportation path. The heavy weight, often in excess of tens of thousands of pounds of such container 100, easily generates vibrations enough to cause the piezoelectric transducer 410 and/or electrostatic transducer 412 to generate DC energy. Optional rectifier 414, in addition with current switch 416, assist in obtaining maximum power output from the arrangement.

It is thus seen then how a structural element such as the frame 320 of the gateway is connected to power, not only the transceiver, but also additional components of the gateway 10. A structural antenna represented by the frame receives electromagnetic energy, such as RF energy, via a connecting line to the transceiver. Within the transceiver RF energy is converted to DC power serving to operate the transceiver.

Separately or simultaneously, a structural antenna element 320 also receives mechanical energy such as via vibration or shock, which is readily converted directly to DC current by means of a piezo electric constriction or transduction to further supply power to the transceiver and other components of the gateway 10. This power may also be used to energize remote sensors 210, 211, and 212 that may themselves be also connected to similar structural antenna elements.

As a result, one advantage of the present invention is that the source of power for the gateway is the structural antenna provided by the frame 320 itself. Therefore, there is no need to provide line power or battery supply power for its operation. As such there will be no need to check for periodic maintenance on the gateway 10 such as to check battery, remaining battery strength, replace the battery and/or make connections to power sources.

The structural antenna column in 320 may receive energy in one or more orientations with respect to an incident wave and/or mechanical force. The structural antenna element may be a resident antenna with mechanical features that establish a comb or plate positioned as proof mass in a selected primary axis within a frame of the gateway 10.

In such an arrangement, under acceleration, the inertia of the structural antenna element 320 works against a resistive force, with energy coupled and dissipated in electromagnetic damper. In the case of the antenna, in couple to a piezo electrostatic damper connected to the antenna frame assembly to thereby generate DC current.

A passive rectifier circuit topology can accept either input by means of a switch and additional bridge rectifier can provide it with typical regulation of the power provided to the transceiver and other components.

While this invention has been particularly shown and described with references to preferred embodiments thereof, it will be understood by those skilled in the art that various changes in form and details may be made therein without departing from the scope of the invention encompassed by the appended claims.

What is claimed is:

1. An apparatus for use with a cargo container comprising:
one or more sensors, for detecting status information relating to the cargo container;
a transceiver, for communicating said detected status information to a central data facility via one or more communication networks;
a processor, for coordinating operation of the transceiver and reception of data from the sensor(s);
a structural antenna element, formed at least partially from a structural portion of the apparatus;
an energy transducer, coupled to the structural antenna element, for deriving an electrical power signal to power said apparatus, by converting ambient electromagnetic energy and/or mechanical energy to which the container is exposed.

2. An apparatus as in claim 1 wherein the cargo container is one of an intermodal cargo container or freight trailer.

3. An apparatus as in claim 1 wherein the sensed status information for the container is selected from a group consisting of positional coordinates, ambient environmental conditions, intrusion, door tampering, contraband detection.

4. An apparatus as in claim 1 wherein the apparatus further comprises:
local networking interface, for receiving status information from like apparatus associated with neighboring containers.

5. An apparatus as in claim 1 wherein the apparatus is installed on multiple containers in an intermodal supply chain.

6. An apparatus as in claim 1 wherein the components thereof are packaged with the container so that they displace no internal volume thereof.

7. An apparatus as in claim 1 wherein the components of the apparatus are entirely contained within the container such that they do not attach to any exterior surface, locking bar or handle of the container, such that a casual observer is given no apparent visual cue of being different from a standard shipping container not so equipped.

8. An apparatus as in claim 1 wherein the transceiver communicates with at least one other apparatus in an adjacent container to form an ad-hoc network to coordinate communication of information to the central data facility in a way that a shipper can maintain integrity information for a shipment comprised of two or more containers.

9. An apparatus as in claim 8 wherein integrity information includes at least tampering with the containers, absence of a previously identified container, anomalies from a pre-established state.

10. An apparatus as in claim 8 wherein the communicated information includes sensor information.

11. An apparatus as in claim 1 wherein the transceiver communicates to identify cargo information, time and location of suspected theft to cue and aid recovery operations.

12. An apparatus as in claim 11 wherein the suspected theft information is reported to one or more of a private theft recovery system, private cargo insurance underwriter system, insurance claim system, law enforcement system, Customs and Border Protection (CBP) system, or government Customs and cargo information clearinghouse system.
